(19) United States
(12) Patent Application Publication
(10) Pub. No.: US 2008/0153932 A1
(43) Pub. Date: Jun. 26, 2008

(54) Uses of waste stream from the production of powder coat

(76) Inventor: Robert C. Brady, Muskegon, MI (US)

Correspondence Address: JOHATHAN P. O''BRIEN;MILLER, CANFIELD, PADDOCK AND STONE, P.L.C., 277 SOUTH ROSE STREET, SUITE 5000, KALAMAZOO, MI, 49007, US

(21) Appl. No.: 12/001,273

(22) Filed: Dec. 11, 2007

Related U.S. Application Data
(60) Provisional application No. 60/874,128, filed on Dec. 11, 2006.

(51) Int. Cl. C08J 11/18

(52) U.S. Cl. 521/48; 521/40; 521/49

(57) ABSTRACT

The invention relates to methods of using polymers in the waste stream obtained from the production of powder coat. The polymer in the waste stream can be cured with that in another waste stream or with a virgin polymer.

### CROSS-REFERENCE

This application claims the benefits of U.S. Application No. 60/874,128, filed on Dec. 11, 2006.

### BACKGROUND OF THE INVENTION

Powder coating is a type of dry coating, which is applied as a free-flowing, dry powder. The main difference between a conventional liquid paint and a powder coating is that, the powder coating does not require a solvent to keep the binder and filler parts in a liquid suspension form. The coating is typically, but not always, applied electrostatically and is then cured under heat to allow it to flow and form a “skin.” Powder coating is usually used to create a hard finish that is tougher than conventional paint. Powder coating is mainly used for coating of metals, such as aluminum extrusions, and automobile and motorcycle parts. Newer technologies allow other materials, such as medium-density fiberboard, to be powder coated using different methods.

The powder used in this surface finishing technology is usually a thermoplastic or a thermoset polymer. The thermoplastic powder will remelt when heated, while the thermosetting powder will not remelt upon reheating. During the curing process (heating in the oven), a chemical cross-linking reaction is triggered at the curing temperature and it is this chemical reaction of the polymer that gives the powder coating many of its desirable properties. For instance, powder coating produces a high specification coating which is relatively hard, abrasion resistant (depending on the specification) and tough; the choice of colors and finishes can be almost limitless; and powder coatings can be applied over a wide range of thickness.

Suitable polymers that can be used to produce powder coat includes, e.g., epoxy polymers, acrylic polymer, unsaturated polyesters, and their hybrids. Powders of epoxy, acrylic, and their hybrids provide excellent adhesion and harness for improved resistance to chipping, abrasion, corrosion, and chemicals. Also, they can be flexible enough to be formable without cracking. Polyester powders provide additional advantages in ultraviolet and weathering resistance.

The powders used for powder coating technology are generally produced by conventional technologies. For instance, equipments, such as a high energy bead milling (HEBM), can be used to grind the bulk materials into powders of a desired size. Powders that can be used for powder coating purposes are generally desired to have a uniform size. Thus, the processes of making the powders often produce a large amount of “waste” which may have different sizes. In addition, during the powder coating process, overspray powders generally results in accumulation of large amount of the dry powders that may not be used again for powder coating. These powders have traditionally been used as a low value material for other applications, e.g., as a filler for making low-quality plastics. Sometimes, they have even been used as a land fill. These uses substantially reduce the value of the polymers contained in the waste streams. Thus, there is a need for new applications that will greatly enhance the values of these waste streams.

### SUMMARY OF THE INVENTION

In one aspect, the invention relates to a method of using the waste stream of a polymer processing process (e.g., production of powder coat), comprising obtaining the waste steam which contains a first reactive polymer, mixing the waste stream and another polymer which contains a second reactive polymer, and copolymerizing the mixture of the waste stream and the other polymer. Examples of the polymer processing process includes production of powder coat, e.g., for surface finishing (painting).

In another aspect, the invention also relates to a method of making a mold compound, comprising obtaining a waste steam of a polymer processing process, and copolymerizing the waste steam with another polymer.

In still another aspect, the invention further relates to the product produced by a method of this invention.

In some embodiments, the ratio of the waste stream and the other polymer is between 0.1 and 10. In some other embodiments, the ratio of the waste stream and the other polymer is between 0.4 and 1.5. In still some other embodiments, the ratio of the waste stream and the other polymer is between 0.8 and 1.2. In yet still some other embodiments, the ratio of the waste stream and the other polymer is about 1.

In some other embodiments, the first reactive polymer is an unsaturated polyester, polyurethane, epoxy polymer, or urethane polymer. In some other embodiments, the second reactive polymer is an unsaturated polyester, polyurethane, epoxy polymer, or urethane polymer.

In some embodiments, the first and second reactive polymers are the same.

In some other embodiments, the methods further include adding a monomer (e.g., styrene) to the mixture of the waste stream and the other polymer before polymerizing the mixture. In still some embodiments, the ratio of the monomer in the mixture is less than 20% by weight.

In some embodiments, the methods further include adding a polymerization inhibitor to the mixture of the waste stream and the other polymer before polymerizing the mixture. A polymerization inhibitor promotes the stability of the polymers and their shelf life. In addition, it can help control the curing process. Examples of suitable polymerization inhibitors include 4-benzylidene-2,6-di-tert-butyl-cyclohexa-2,5 dienone, p-tert-butylcatechol, diallyl phthalate, and para-benzoquinone.

In some embodiments, the methods further include adding a polymerization accelerator to the mixture of the waste stream and the other polymer before polymerizing the mixture. Examples of the polymerization accelerator include t-butyl peroxy-2-ethylhexanote, t-butyl hydroperoxide, t-butyl peroxybenzoate, t-butyl hydroperoxide, or di-t-butyl peroxide.

In some embodiments, the mixture of the waste stream and the other polymer further includes an inert compound. Examples of the inert compounds include calcium carbonate, calcium sterate, silica, and alumina trihydrate, and wood flour.

In still some other embodiments, the polymerization (curing) step is conducted with a catalyst.

### DETAILED DESCRIPTION OF THE INVENTION

The present invention relates to methods of using waste streams in the production of powder coat in surface finishing technology. The term “waste steam” refer to the side-products produced in the manufacturing of powder coat, wherein the side-products may differ from the powder coat product, e.g., by size of particles or by the difference in the composition. It can also refer to the dry powders that, due to overspay in powder coating technologies, do not stay on the surface of a subject and accumulates as a waste.

The waste streams suitable for this invention generally contain such polymers as polyester (unsaturated, or saturated with monomers), epoxy polymers, acrylic polymers, or their hybrids. Because these polymers all contain a functional group, they can be further processed, e.g., cured to make mold compounds.

Unsaturated polyesters generally contain carbon-carbon double bonds, either in the main polymer backbone or in their branches. Similar to the polymerization of free olefin monomers in which the double bond is activated by a free radical or an ion (anionic or cationic) which leads to the formation of a network of the monomer, the double bonds in the unsaturated polyesters can also undergo such a polymerization process and form a secondary or additional network, in addition to the preexisting network form in the polyester (formed by the creation of ester groups in the polymer backbone).

Free radicals can be created by using a commonly used free radical agent, e.g., azobisisobutyronitrile or an organic peroxide such as acetyl peroxide, benzoyl peroxide, dicumyl peroxide, di-t-butyl peroxide, or t-butyl hydroperoxide. Similarly, cation and anion can also be created by using such a compound as AlCl₃, BF₃, SnCl₄, SbCl₅, ZnCl₂, TiCl₄, PCl₃, iodine, chlorine, or bromine.

In addition to unsaturated polyesters, a saturated polyester which is mixed with a monomer, e.g., styrene, can also form a secondary or additional network. In this case, the monomer undergoes a polymerization process, e.g., initiated by free radical, cation, or anion, and this new polymer network intertwines with the preexisting polyester network and form a cross-linked (or cured) polymer. In addition to curing the polyester resin, the monomer also acts as a solvent in order to adjust the viscosity of the formulation and the performances of the final product.

Epoxy polymers or polyepoxides are thermosetting epoxide polymers. Most common epoxy resins are produced from a reaction between epichlorohydrin and bisphenol-A. Similar to polyester, an epoxy polymer can be further polymerized with a free radical, anion or cation and thus “cured,” due to the reactive epoxy groups which are generally the terminal groups of the polymer. With the same initiation (free radical or ionic), the mechanism of the curing process is generally the same as that for curing the polyester resin.

Acrylic polymers (e.g., polymethylmethacrylate) are usually made from acrylic monomers such as methacrylate and generally contain branch ester groups. As ester groups are generally reactive, under certain conditions and with appropriate initiators, acrylic polymers can also undergo further polymerization, e.g., with a diol, and thus be cured.

As the waste stream of powder coat production contains reactive polymers, it can be mixed with other polymer resins and subsequently be cured to obtain a uniform material, e.g., a molding compound. The other polymer resins can be the same as the polymers contained in the waste stream, e.g., a virgin polymer of the same chemical composition. As used herein, the term “virgin polymer” refers to a polymer that has not been used since its production and thus free of other substances (e.g., solvent, initiator, or inhibitor) or impurities. The virgin polymer can be a single polymer or a mixture or two or more virgin polymers. The weight ratio of the waste stream to the virgin polymer can be in the range of 0.1 to 10 (e.g., 0.2 to 5, 0.5 to 2, or about 1). The curing process can be initiated with a suitable initiator (e.g., a free-radical, an anion, a cation, or a reactive compound) and under appropriate conditions (e.g., at a temperature in the range of 30 to 80° C.).

The waste stream of a powder coat production can also be mixed with the waste stream of another powder coat production, and the mixture is then cured with an appropriate initiator and under appropriate conditions (e.g., at a temperature in the range of 30 to 80° C.).

The product obtained by curing the mixture of a waste stream and a virgin polymer, or of 2 different waste steams unexpectedly have excellent properties (e.g., physical properties or mechanical properties) that are generally observed in products obtained from curing one or more virgin polymers. For instance, they have shown modulus and flexural strength comparable with those of polymers obtained from curing completely virgin polymers. The cured products have shown the same or similar uniformity as that from the completely virgin polymers, as evidenced by narrow peaks of transition temperature (Tg). As such, they can be used for the same applications as those molding compounds produced by using all virgin polymers.

The following examples are illustrative of the present invention and shall not be construed to limit the scope of the invention.

### Example 1

A first mixture was obtained by mixing 612.9 g of powder coat waste stream (from Steelcase Inc., Grand Rapids, Mich., U.S.A.), and 100 g of styrene monomer (Lyondell Chemical Company, Houston, Tex., U.S.A.). To the first mixture was added the following materials to obtain a second mixture: 368.88 g of Stypol 040-2701 (an unsaturated polyester resin solution, available from Cook Composites and Polymers Co., North Kansas City, Mo., U.S.A.), 185.5 g of Stypol 040-0165 (polystyrene resin in monomer, available from Cook Composites and Polymers Co.), 5.5 g of t-butyl peroxide-2-ethylhexanote blend in odorless mineral spirits (available as LUPEROX 26M50 from ARKEMA Inc., Philadelphia, Pa., U.S.A.), 8.6 g of LUPEROX P (containing t-butyl peroxybenzoate, t-butyl hydroperoxide, and di-t-butyl peroxide; and available as from ARKEMA, Inc.) as accelerator, 4.1 g Modifier E (containing diallyl phthalate, and para-benzoquinone and available from Ashland Chemical Company, Covington, Ky., U.S.A.) as inhibitor, 52.66 g of calcium sterate (as a filler and aid for internal mold release), 2,270.00 g of filler, and 585.66 g of fiber glass (PPG Industries, Inc., Pittsburgh, Pa., U.S.A.). The second mixture was then cured under the heat at 300° F. for 1-2 minutes to obtain a molding compound.

The molding compound exhibited tensile strength and tensile modulus of about 3548 psi and 1,805,408 psi, respectively. These modulus are higher than those of molding compounds prepared with a virgin polymer (2,271 psi and 1,542,350 psi, respectively), which is unexpected and probably due to the fact that the polymer in the powder coat is completely cross-linked with styrene.

### Example 2

A first mixture was obtained by mixing 40,406 g of powder coat waste stream (from Steelcase Inc., Grand Rapids, Mich.), and 6,591 g of styrene monomer (Lyondell Chemical Company, Houston, Tex.). To the first mixture was then added the following materials to obtain a second mixture: 14,301 g of Stypol 040-2701 (an unsaturated polyester resin solution, available from Cook Composites and Polymers Co., North Kansas City, Mo.), 7,082.4 g of Stypol 040-0165 (polystyrene resin in monomer, available from Cook Composites and Polymers Co., North Kansas City, Mo.), 213.38 g of LUPEROX 26M50 (containing t-butyl peroxy-2-ethylhexanote and t-butyl hydroperoxide; and available as from ARKEMA Inc., Philadelphia, Pa., U.S.A.) as accelerator, 1,362 g of carbon black polymer dispersion as pigment (available as PC-80002 from American Colors Inc., Sandusky, Ohio, U.S.A.), 335.96 g of an organic peroxide blend containing t-butyl peroxybenzoate, t-butyl hydroperoxide, and di-t-butyl peroxide (available as LUPEROX P from ARKEMA, Inc.), 158.9 g Modifier E (from Ashland Chemical Co., Covington, Ky.) as inhibitor, 2,043 g of calcium sterate, 87,282 g of filler, 22,700 g of fiber glass (PPG Industries, Inc., Pittsburgh, Pa.). The second mixture was then cured under the heat at 300° F. for 1-2 minutes to obtain a molding compound.

The molding compound exhibited tensile strength and tensile modulus of about 8,706 psi and 2,029,423 psi, which are also higher than those of the material prepared with a virgin polymer.

### Other Embodiments of the Invention

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of using the waste stream of a polymer processing process, comprising obtaining the waste steam which contains a first reactive polymer, mixing the waste stream and another polymer which contains a second reactive polymer, and copolymerizing the mixture of the waste stream and the other polymer.

2. The method of claim 1, wherein the ratio of the waste stream and the other polymer is between 0.1 and 10.

3. The method of claim 2, wherein the ratio of the waste stream and the other polymer is between 0.4 and 1.5.

4. The method of claim 3, wherein the ratio of the waste stream and the other polymer is between 0.8 and 1.2.

5. The method of claim 4, wherein the ratio of the waste stream and the other polymer is about 1.

6. The method of claim 5, wherein the first reactive polymer is an unsaturated polyester, polyurethane, epoxy polymer, or urethane polymer.

7. The method of claim 5, wherein the second reactive polymer is an unsaturated polyester, polyurethane, epoxy polymer, or urethane polymer.

8. The method of claim 1, wherein the first and second reactive polymers are the same.

9. The method of claim 1, further comprising adding a monomer to the mixture of the waste stream and the other polymer before polymerizing the mixture.

10. The method of claim 9, wherein the monomer is styrene.

11. The method of claim 9, wherein the ratio of the monomer in the mixture is less than 20% by weight.

12. The method of claim 1, further comprising adding a polymerization inhibitor to the mixture of the waste stream and the other polymer before polymerizing the mixture.

13. The method of claim 12, wherein the polymerization inhibitor is 4-benzylidene-2,6-di-tert-butyl-cyclohexa-2,5 dienone, p-tert-butylcatechol, diallyl phthalate, or para-benzoquinone.

14. The method of claim 1, further comprising adding a polymerization accelerator to the mixture of the waste stream and the other polymer before polymerizing the mixture.

15. The method of claim 14, wherein the polymerization accelerator is t-butyl peroxy-2-ethylhexanote, t-butyl hydroperoxide, t-butyl peroxybenzoate, t-butyl hydroperoxide, or di-t-butyl peroxide.

16. The method of claim 1, wherein the mixture of the waste stream and the other polymer further includes an inert compound.

17. The method of claim 16, wherein the inert compound is calcium carbonate, calcium sterate, silica, or aluminum trihydrate.

18. The method of claim 17, wherein the polymerization step is conducted with a catalyst.

19. A method of making a mold compound, comprising obtaining a waste steam of a polymer processing process, and copolymerizing the waste steam with another polymer.

20. The method of claim 19, wherein the ratio of the waste stream and the other polymer is between 0.1 and 10.

21. The method of claim 20, wherein the ratio of the waste stream and the other polymer is between 0.4 and 1.5.

22. The method of claim 21, wherein the ratio of the waste stream and the other polymer is between 0.8 and 1.2.

23. The method of claim 22, wherein the ratio of the waste stream and the other polymer is about 1.

24. The method of claim 23, wherein the first reactive polymer is an unsaturated polyester, polyurethane, epoxy polymer, or urethane polymer.

25. The method of claim 23, wherein the second reactive polymer is an unsaturated polyester, polyurethane, epoxy polymer, or urethane polymer.

26. The method of claim 19, wherein the first and second reactive polymers are the same.

27. The method of claim 19, further comprising adding a monomer to the mixture of the waste stream and the other polymer before polymerizing the mixture.

28. The method of claim 27, wherein the monomer is styrene.

29. The method of claim 27, wherein the ratio of the monomer in the mixture is less than 20% by weight.

30. The method of claim 19, further comprising adding a polymerization inhibitor to the mixture of the waste stream and the other polymer before polymerizing the mixture.

31. The method of claim 30, wherein the polymerization inhibitor is 4-benzylidene-2,6-di-tert-butyl-cyclohexa-2,5 dienone, p-tert-butylcatechol, diallyl phthalate, or para-benzoquinone.

32. The method of claim 19, further comprising adding a polymerization accelerator to the mixture of the waste stream and the other polymer before polymerizing the mixture.

33. The method of claim 32, wherein the polymerization accelerator is t-butyl peroxy-2-ethylhexanote, t-butyl hydroperoxide, t-butyl peroxybenzoate, t-butyl hydroperoxide, or di-t-butyl peroxide.

34. The method of claim 19, wherein the mixture of the waste stream and the other polymer further includes an inert compound.

35. The method of claim 34, wherein the inert compound is calcium carbonate, calcium sterate, silica, or aluminum trihydrate.

36. The method of claim 35, wherein the polymerization step is conducted with a catalyst.

37. A mold compound which is made by the method of claim 1 or 19.
